(19) United States
(12) Patent Application Publication
(10) Pub. No.: US 2008/0111357 A1
(43) Pub. Date: May 15, 2008

(54) Airbag Device With A Destructible Connection Section Between A Gas Generator And A Non-Metallic Gas Lance

(76) Inventors: Rolf Heninger, Munich (DE); Hakan Jaconelli, Alingsas (SE); Jonas Malmenstam, Alingsas (SE)

Correspondence Address: BRINKS HOFER GILSON & LIONE, P.O. BOX 10395, CHICAGO, IL, 60610, US

(21) Appl. No.: 11/666,840

(22) PCT Filed: Oct. 31, 2005
(86) PCT No.: PCT/EP05/11641

§ 371 Date: Oct. 9, 2007

(30) Foreign Application Priority Data
Nov. 1, 2004 (DE) 202004016975.4

(51) Int. Cl. B60R 21/26

(52) U.S. Cl. 280/740; 280/741

(57) ABSTRACT

The invention relates to an airbag device comprising a gas generator, at one end of which a diffuser with radial discharge ports is positioned with a joining section. A non-metallic gas lance is fixed to the joining section upstream of the diffuser. The non-metallic gas lance is provided with or is plugged onto a reinforcing means at the axial end thereof that is associated with the joining section. The reinforcing means redirects the gas flow from the diffuser from a radial discharge direction thereof to an axial discharge direction during normal operation of the gas generator In case of an extremely applied high temperature capable of causing self-ignition of the gas generator, the gas lance material and the reinforcing means are destroyed, as a result of which the gas flow is no longer redircted to the axial direction thereby preventing the gas generator from acting as a rocket which could be hazardous.

### CROSS REFERENCE TO RELATED APPLICATIONS

This application claims priority to German Patent Application No. 20 2004 016 975.4, filed Nov. 1, 2004 and PCT/EP2005/011641, filed Oct. 31, 2005.

### FIELD OF THE INVENTION

The invention relates to an airbag device with a gas generator and a non-metallic gas lance.

### BACKGROUND OF THE INVENTION

It is known that an airbag device is provided with a gas generator with an outlet opening, through which, if the airbag is triggered, hot gas exits through combustion of a chemical propellant, which can be ducted to an airbag for expansion of the same via suitable gas feed devices. If the airbag device is a so-called “curtain airbag”, where the airbag unfolds in the area of a vehicle side window, the gas generated by the gas generator in the restraint case, is generally led to the airbag through a relatively long gas lance. This gas lance can consist of metal, but lances made of plastic or textile material are also used.

In order to connect the gas generator with a gas lance in the form of a rigid tube, the method of forming a connecting section of this gas lance with a double wall by turning over its one end is known from DE 102 55 067 A1. This design measure provides a connecting section of the gas lance to the gas generator which is particularly stable from the mechanical point of view.

From GB 23 14 300 A it is also known that a textile tube-shaped gas feed device for an airbag mounted in the area of a vehicle window can be formed so as to have a double wall by turning over its free end and pulling it into the gas feed device. This means that this textile gas lance is formed so as to be mechanically reinforced in the area which is intended for fixing to the outlet connection of the gas generator.

Taking this state of the art into consideration, the technical problem exists, that a gas generator as well as a gas feed device which is fixed to it should cooperate in a fashion which is thrust-neutral if the gas generator is unintentionally triggered because of high temperature influence from the outside, for example during manufacture, storage in a storage room, or during transport of the gas generator from this storage room to the location where it is to be integrated into a motor vehicle.

The expression “thrust-neutral” is used to mean here that the gas generator, with a gas lance mounted on it, in the case of a strong temperature influence, such as for example fire, should not in any event react with outflow of the gas generated by the gas generator in an axial direction if the gas generator unintentionally self-ignites.

This invention is therefore based on the task of presenting a gas feed device for an airbag device which, in the case of temperature influence from the outside acting on the gas generator as well as on the connection area of same with a gas lance, reacts in a fashion which is neutral with regard to thrust in case of unintended self-ignition.

The invention is based on the recognition that thrust-neutrality of a gas generator with a diffuser on its end at the outflow side and a non-metallic gas lance fixed on the gas generator can be achieved in the presence of very strong temperature influence from the outside acting on these elements, as well as associated self-ignition of the gas generator, can be achieved if the gas generator is, in the area of its diffuser, covered by a reinforcement means, which resists the temperature influence of the gas of the gas generator in normal operation, but which is destroyed in case of additional temperature influence from the outside.

Therefore the invention starts from an airbag device with a gas generator at whose one end a diffuser with radial outflow openings is arranged, and on which a connection section is formed, on which a non-metallic gas lance is fixed upstream of the diffuser, with the diffuser being accommodated coaxially. The diffuser may be a separate component, which is fixed to an end area of the gas generator, or it may be a diffuser which is integrated in the gas generator.

In order to solve the set task, it is additionally provided for that the non-metallic gas lance at its axial end assigned to the connection section is provided with a reinforcement means or is placed upon such a means, which on the one hand in normal operation of gas generator, diverts gas stream of a diffuser from its radial flow-off direction into an axial flow-off direction, and also effects a temperature-effective reinforcement of the gas lance in the connection section. On the other hand in the case of a strong temperature influence from the outside on the connection section as well as self-ignition of gas generator, leads to destruction of the gas lance material along with the reinforcement means, as a result of which diversion of gas stream from radial to axial directions is cancelled.

As a result, the desired thrust-neutrality of the gas generator is created by the proposed structure of the airbag device means in that the gas of the gas generator stream is no longer, as in normal operating condition, diverted in axial direction, but can stream off radially from the diffuser. This means that, in case of unintentional self-ignition, the gas generator does not behave like an uncontrolled rocket, from which risks and hazards can emanate, but basically rotates on the same spot around an associated rotational axis.

According to a first variant of the invention, it can be provided that the reinforcement means is in the form of a sleeve of textile material, plastic or thin metal sheet located between the diffuser and the gas lance, while a second variant provides that the reinforcement means is in the form of an axial turn of the gas lance material into the gas lance.

With regard to the material of the reinforcement means, it is considered useful if the reinforcement means is able to resist the temperature influence of the outflowing gas of the gas generator alone, but if there is an additional temperature influence from an outside heat source, the reinforcement means fails thermally and mechanically, so that the gas flow of the gas generator can flow radially via the diffuser.

In particular, the reinforcement means should preferably consist of a material which, in case of temperature influence from an outside heat source, fails thermally and mechanically, before the gas generator ignites itself in unwanted fashion because of this outside temperature influence.

Such a material could be, for example, a composite material, whose surface which points toward the diffuser is thermally well insulated but not particularly stable from the mechanical point of view, while its outer side is mechanically stable, but does not exhibit high temperature resistance. Under normal operating conditions, the inner radial insulation layer protects the radial outer area of the reinforcement means against temperature-related destruction, while this area fails when heat affects these reinforcement means from the outside.

In this embodiment of the invention it is achieved that the aforementioned desired flow-off behaviour is present after the self-ignition of the gas generator.

In addition, it is considered advantageous in order to reduce manufacturing costs, if the reinforcement means and the axial end of the gas lance on the inflow side are fixed to the connection section of the gas generator by means of a common fixing means. The reinforcement means can advantageously be fixed inside the gas lance (for example by means of sewing or bonding).

Finally it is advantageously provided for that the length of the reinforcement means is selected in such a way that the reinforcement means covers the radial outflow openings of the diffuser and does not extend beyond the openings substantially.

### BRIEF DESCRIPTION OF THE DRAWING

The invention will be now be described in more detail by means of the drawing, in which two embodiments are shown.

FIG. 1 shows a schematic sectional representation of an airbag device in the connection area between a gas generator and a gas lance; and

FIGS. 2 to 4 show a section of a curtain airbag with flexible gas lance and the manufacture of a thermally reinforced connection section to the gas generator by means of a turn in.

### DETAILED DESCRIPTION OF THE INVENTION

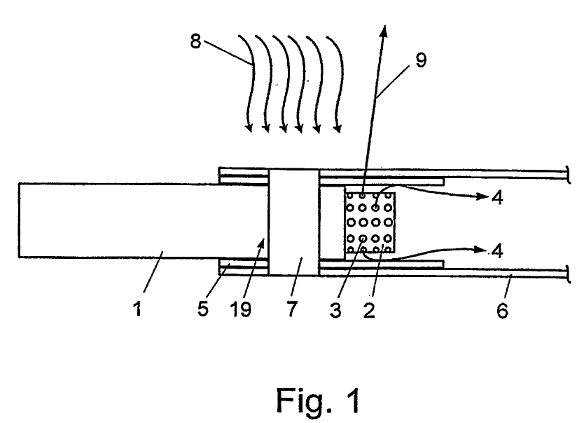

As can be seen in FIG. 1, a generally cylindrical gas generator 1 is provided at its axial end on the outflow side with a diffuser 2, through whose outflow openings 3 the gas generated by the gas generator can flow off. The gas stream is spatially distributed by this diffuser 2 in a known manner, so that the temperature load to a gas lance 6 fixed on gas generator 1 upstream of diffuser 2 is maintained within controllable limits.

As shown here, gas lance 6 consists of a non-metallic, preferably flexible material, which can be a textile fabric. In a different embodiment, the gas lance consists of a plastic material.

In order to achieve thermal protection of this gas lance 6, the first variant of the invention shown in FIG. 1 provides that radially between diffuser 2 and gas lance 6 a reinforcement means is located in the form of a sleeve 5 which is more temperature stable. This sleeve together with gas lance 6 is fixed to a connection section 19 of gas generator 1 with a fixing means 7, for example a pipe clamp.

As FIG. 1 makes clear, the gas generated by gas generator 1 streams at least partly radially out of diffuser 2. This gas stream then meets the reinforcement means formed as sleeve 5, which causes gas stream 4 to be deflected axially into gas lance 6. The material of sleeve 5 and gas lance 6 are selected so that they withstand the temperature and mechanical effects during normal operation and deployment of the gas generator.

However, as soon as in addition to the hot gas of gas generator 1 or alone an outside temperature influence 8 acting on these components occurs, for example because of fire, the material of gas lance 6 as well as the reinforcement means provided in the form of sleeve 5 is destroyed. This ensures that following a self-ignition, the gas generated by gas generator 1, in this exceptional case, which can occur, for example, through a fire in a storeroom for such airbag devices, can leave diffuser 2 without axial deflection. This component behaviour ensures that the gas generator does not fly through the air like an uncontrolled rocket in case of such a fire, but only rotates around its rotational axis.

If the gas generator behaves in a somewhat less favourable way, in the simplest case it is sufficient, depending on the length of sleeve 5, if in the case of the temperature influence 8 from the outside, the material of the gas lance does not withstand the temperature load from the sum of the heat of the gas flow and the heat from outside, and is therefore destroyed.

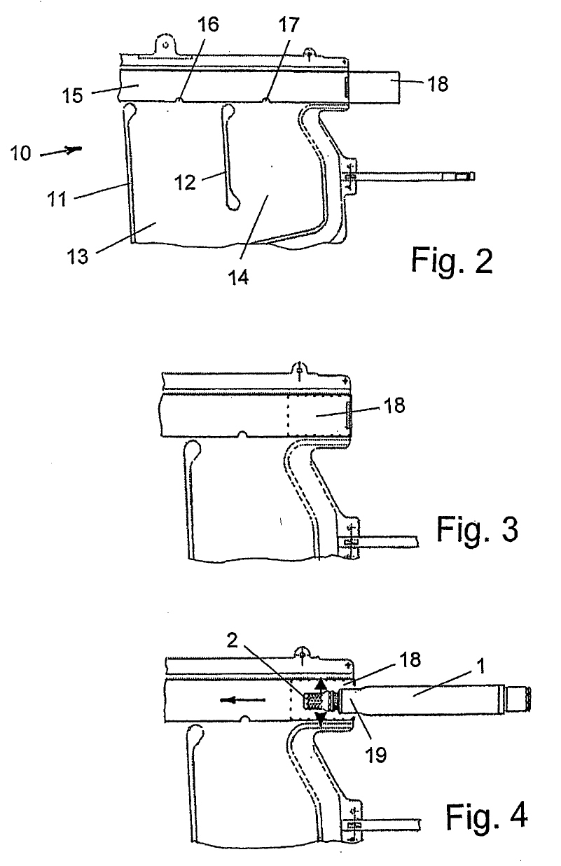

FIGS. 2 to 4 show a different embodiment of the invention, in which a so-called curtain airbag 10, of which only some parts are shown, consists of a textile fabric which is divided into individual gas chambers 13, 14 by means of seams 11, 12. In addition, in an upper section of airbag 10, a textile gas lance 15 is introduced or formed, through whose outflow openings 16 and 17 both airbag chambers 13 and 14 can be filled with the gas generated by gas generator 1 in cases when restraint of the vehicle occupant(s) is needed.

In order to solve the task on which the invention is based, it is here provided for that gas lance 15 exhibits a turnover section at its axial end 18 directed towards gas generator 1, which can be turned into gas lance 15 in order to form a temperature-effective reinforcement area. Gas generator 1 is then introduced into this reinforcement area 18 with its diffuser 2 and then mechanically connected to airbag 10 and gas lance 15.

As FIG. 4 particularly shows, the gas generated by gas generator 1 in the case that the vehicle occupant(s) have to be restrained is diverted in this reinforcement section 18, created by turning over, from a radial outflow direction into an axial outflow direction.

In the case of a temperature influence 8 from the outside, for example caused by fire, this reinforcement section 18, because of its structure and/or its material characteristics, is destroyed in the same way as is shown in the example in connection with FIG. 1, so that it is possible for the gas stream generated by gas generator 1 and diverted by diffuser 2, to flow off radially.

While the above description constitutes the preferred embodiment of the present invention, it will be appreciated that the invention is susceptible to modification, variation, and change without departing from the proper scope and fair meaning of the accompanying claims.

1. An airbag device comprising a gas generator having a diffuser attached with radial outflow openings, and on which a connection section is formed, a non-metallic gas lance fixed upstream of the diffuser and accommodating the diffuser in a co-axial fashion, the non-metallic gas lance at its axial end adjacent to the connection section is provided with a reinforcement means, which in normal operation of gas generator, diverts gas stream of diffuser from a radial flow-off direction into an axial flow-off direction, and also effects a temperature-effective reinforcement of the gas lance, and in the case of a strong temperature influence from the outside on the connection section, leads to destruction of the gas lance material along with the reinforcement means, as a result of which diversion of gas stream from radial to axial direction does not occur upon self-ignition of the gas generator.

2. An airbag device according to claim 1, wherein the reinforcement means is in the form of a sleeve of textile material, plastic or thin metal sheet located between the diffuser and the gas lance.

3. An airbag device according to claim 1, wherein the reinforcement means consists of a material which, in case of the temperature influence fails thermally and mechanically because of an outside heat source, before the gas generator self-ignites because of the outside temperature influence.

4. An airbag device according to claim 2, wherein the reinforcement means is formed as a composite material, whose side pointing towards the diffuser is thermally insulating, but not mechanically stable, while the outer side of the reinforcement means is mechanically stable, but not highly temperature resistant.

5. An airbag device according to claim 1, wherein the reinforcement means is formed as a turn in gas lance material into the gas lance.

6. An airbag device according to claim 1 wherein the reinforcement means, and the axial end of the gas lance on the inflow side are fixed to the connection section of the gas generator with a joint fixing means.

7. An airbag device according to claim 1 wherein the reinforcement means is fixed inside the inflow side end of the gas lance by means of sewing or gluing.

8. An airbag device according to claim 1 wherein the length of the reinforcement means is selected in such that the reinforcement means covers the radial outflow openings of the diffuser and does not extend more than slightly beyond the reinforcement means.
